(19) United States
(12) Patent Application Publication
(10) Pub. No.: US 2003/0195814 A1
(43) Pub. Date: Oct. 16, 2003

(54) Wireless house server and methods for doing business by communicating with the wireless house server

(75) Inventor: Bryan Lester Striemer, Zumbrota, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY

(21) Appl. No.: 10/120,737

(22) Filed: Apr. 11, 2002

(51) Int. Cl. G06F 17/60

(52) U.S. Cl. 705/26

(57) ABSTRACT

A mobile wireless device is used to communicate with one or more wireless devices that correspond to predetermined physical locations. A product/service provider uses a mobile wireless device to broadcast a first digital message to one or more wireless devices that are within range of the mobile wireless device and that correspond to physical locations. A wireless device at a physical location responds to the first digital message by sending a second digital message to the mobile wireless device to provide requested information. The product/service provider then acts in accordance with the information in the second digital message. In this way, a product/service provider receives information that allows the driver to determine an appropriate course of action.

### BACKGROUND OF THE INVENTION

1. Technical Field

This invention generally relates to computer systems, and more specifically relates to the integration of wireless devices with computer systems.

2. Background Art

Many aspects of our modem life include an ironic mix of new and old technology. For example, package shipping companies such as United Parcel Service (UPS) and FedEx employ sophisticated systems for tracking a package from the time it is picked up to the time it is delivered. Most include the capability of signing on an electronic tablet to indicate receipt of the package. Yet the electronic conveniences these package shippers use do not extend to providing electronic information exchange with customers. As a result, if a person is not at home when a package arrives, the driver has no information about whether there are suitable alternatives for package delivery when the recipient is not home. If the recipient is a frequent recipient of packages, he or she may verbally tell the driver what to do if he or she is not home. This, however, is problematic because it requires that the driver remember the verbal instructions, and because these instructions cannot be easily conveyed to a substitute driver or to a new driver. As a result, customers are often frustrated in the limitations that exist in dealing with current package shipping companies.

A similar problem exists with the delivery of mail through the U.S. Postal Service. When a person goes on vacation for two weeks, he or she may request to stop the delivery of mail for those two weeks, and that the stopped mail be held in the post office until their return. This requires the person to fill out a paper form that is filed in the post office. Ofttimes the letter carrier does not get word of the suspension of delivery, especially if a substitute carrier is used during the two week period. As a result, mail is often delivered when it should be held, resulting in frustration for mail customers. Similar problems often result when customers attempt to suspend delivery of newspapers while on vacation. Without a way to provide two-way communication between a company and a customer, customers will continue to be frustrated at poor service that results from not being able to convey their wants and needs electronically to the company.

### DISCLOSURE OF INVENTION

According to the preferred embodiments, a mobile wireless device is used to communicate with one or more wireless devices that correspond to predetermined physical locations. A product/service provider uses a mobile wireless device to broadcast a first digital message to one or more wireless devices that are within range of the mobile wireless device and that correspond to physical locations. A wireless device at a physical location responds to the first digital message by sending a second digital message to the mobile wireless device to provide requested information. The product/service provider then acts in accordance with the information in the second digital message. In this way, a product/service provider receives information that allows the driver to determine an appropriate course of action.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a computer system in accordance with the preferred embodiments;

FIG. 2 is a flow diagram of a method for doing business in accordance with the preferred embodiments that includes exchanging two-way information between a company's representative and a customer;

FIG. 3 is a flow diagram of a method for a company to do business in accordance with the preferred embodiments that includes a customer's wireless device corresponding to a specified location providing a digital message with delivery instructions in response to a digital message received from a mobile wireless device of the company;

FIG. 4 is a flow diagram of a method for an emergency service company to do business in accordance with the preferred embodiments that includes transmitting a digital message from an emergency vehicle when the vehicle comes in proximity to the location of the emergency, and receiving a digital message from a wireless device at the location that provides information regarding the location that would be helpful to the emergency service personnel;

FIG. 5 is a flow diagram of a method for a company that delivers products to customers to do business in accordance with the preferred embodiments, where the method includes the step of activating a signaling device to help the driver locate the right place to deliver the products;

FIG. 6 is a flow diagram of a method for a company that sells products from a vehicle to do business in accordance with the preferred embodiments; and

FIG. 7 is a flow diagram of a method for a monitoring company to do business in accordance with the preferred embodiments.

### BEST MODE FOR CARRYING OUT THE INVENTION

Overview

The preferred embodiments relate to wireless communications to electronic devices using a local wireless interface, such as Bluetooth. To understand the context of the invention, a general discussion of the Bluetooth standard for wireless communication is provided below.

### Bluetooth

Bluetooth wireless technology is a worldwide specification for a small-form factor, low-cost radio solution that provides links between mobile computers, mobile phones, other portable handheld devices, and connectivity to the Internet. The specification is developed, published and promoted by the Bluetooth Special Interest Group (SIG). The Bluetooth Special Interest Group (SIG) is a trade association comprised of leaders in the telecommunications, computing, and network industries, and is driving development of the technology and bringing it to market. The Bluetooth SIG promoters include IBM, 3Com, Agere, Ericsson, Intel, Microsoft, Motorola, Nokia and Toshiba, and hundreds of associate and adopter member companies.

Bluetooth wireless technology is unique in its breadth of applications. Links can be established between groups of products simultaneously or between individual products and the Internet. While point-to-point connections are supported, the specification allows up to seven simultaneous connections to be established and maintained by a single radio. This flexibility, combined with strict interoperability requirements, has led to support for Bluetooth wireless technology from a wide range of market segments, including software developers, silicon vendors, peripheral and camera manufacturers, mobile PC manufacturers and handheld device developers, consumer electronics manufacturers, car manufacturers, and test and measurement equipment manufacturers.

Hardware that complies with the Bluetooth wireless specification ensures communication compatibility worldwide. Bluetooth is generally designed to operate in a maximum range of one to one hundred meters, depending on the class of the device. Class 1 devices have a range up to 100 meters. Class 2 devices have a range up to ten meters. Class 3 devices have a range up to 1 meter. As a low-cost, low-power solution with industry-wide support, Bluetooth wireless technology allows effortlessly interconnecting with compatible devices all over the world.

Devices enabled with Bluetooth wireless technology will be able to: free electronic accessories and peripherals from wired connections; exchange files, business cards, and calendar appointments; transfer and synchronize data wirelessly; take advantage of localized content services in public areas; and function as remote controls, keys, tickets and e-cash wallets.

Many manufacturers of electronic devices are planning to integrate Bluetooth into their devices so their devices can automatically connect to other devices that have a Bluetooth interface within a short range. One goal of Bluetooth is to interconnect many electronic devices without using hard-wire cables. For example, a computer network that includes four computer systems, four monitors, a printer, and a scanner could theoretically be all interconnected via Bluetooth without using any cables to interconnect these items.

Bluetooth includes the capability of identifying each type of device as it establishes a link to other devices. Thus, a printer that has a Bluetooth interface will identify itself as a printer, which makes the print function available to other devices that are linked via Bluetooth to the printer. A mobile phone that includes a Bluetooth interface could automatically detect when it comes in range of a printer that has a Bluetooth interface, and in response to detecting the printer the mobile phone could provide an option to print e-mail or other text information received by the mobile phone, which would send the e-mail or other information to the printer. Details regarding Bluetooth and it's detailed specification may be found at www.bluetooth.com.

Unlike many other wireless standards, the Bluetooth wireless specification includes both link layer and application layer definitions for product developers. Radios that comply with the Bluetooth wireless specification operate in the unlicensed, 2.4 GHz radio spectrum ensuring communication compatibility worldwide. These radios use a spread spectrum, frequency hopping, full-duplex signal at up to 1600 hops/sec. The signal hops among 79 frequencies at 1 MHz intervals to give a high degree of interference immunity.

The 2.4 GHz band used by Bluetooth is unlicensed, and can be used by many other types of devices such as cordless phones, microwave ovens, and baby monitors. Any device designed for use in an unlicensed band should be designed for robustness in the presence of interference, and the Bluetooth wireless technology has many features that provide such robustness.

Products that incorporate a Bluetooth interface are already on the market. Nokia Corp. is selling its Bluetooth 6310 phones in Europe, and are expected to be available in the United States sometime in 2002. Broadcom Corp. and handheld PC maker Palm Inc. plan to co-develop a new Bluetooth handheld PC design.

### Other Wireless Standards

There are other wireless standards that exist besides Bluetooth. For example, Wi-Fi (IEEE 802.11b) is designed to provide wireless Ethernet connectivity that can extend or replace wired networks for dozens of computing devices. Wi-Fi is a trademark of WECA (the Wireless Ethernet Compatibility Alliance). The Bluetooth wireless technology is expected to be used widely as a cable replacement for devices such as PDAs, cell phones, cameras, speakers, headsets and so on. IEEE 802.11 will likely still be used for higher speed wireless Ethernet access, so it is widely expected that Bluetooth and 802.11 will co-exist. Preliminary tests by the Pennsylvania State University's Applied Research Laboratory show that Bluetooth and 802.11b (Wi-Fi) do not interfere with each other even in close proximity. IEEE 802.11(b)'s typical 284-foot range was unaffected by the presence of Bluetooth devices, while Bluetooth's typical 64-foot range was unaffected by the presence of 802.11(b) devices.

### DETAILED DESCRIPTION

The preferred embodiments provide ways for a company to do business with its customers by sending a company representative to the physical area of the customer, sending a digital message via a mobile wireless device to the customer's wireless device, and receiving information from the customer that informs the company representative what action is appropriate under the circumstances. In the preferred embodiments, the customer's wireless device is part of a house web server computer system.

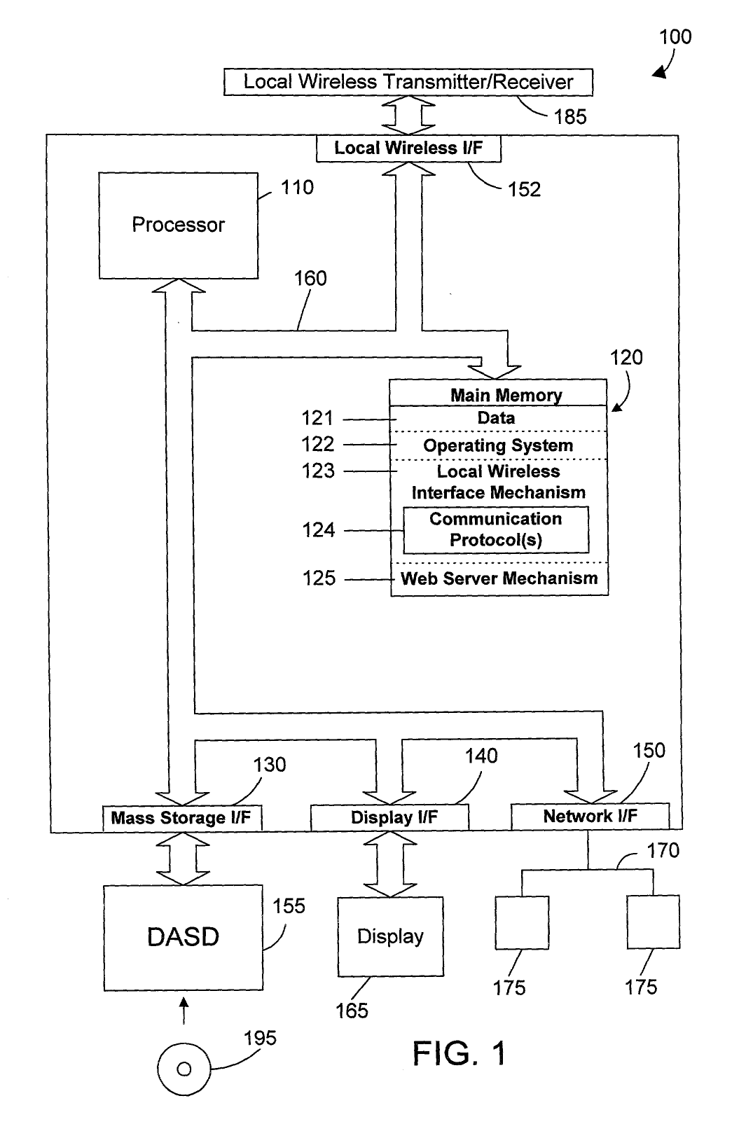

One suitable implementation of a house web server computer system 100 in accordance with the preferred embodiments of the invention is shown in FIG. 1. Web server computer system 100 is preferably an IBM personal computer. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, a network interface 150, and a local wireless interface 152. These system components are interconnected through the use of a system bus 160. Mass storage interface 130 is used to connect mass storage devices (such as a direct access storage device 155) to computer system 100. One specific type of direct access storage device 155 is a readable and writable CD ROM drive, which may store data to and read data from a CD ROM 195.

Main memory 120 in accordance with the preferred embodiments contains data 121, an operating system 122, a local wireless interface mechanism 123, and a web server mechanism 125. Data 121 represents any data that serves as input to or output from any program in computer system 100. Operating system 122 is a multitasking operating system known in the industry as OS/2; however, those skilled in the art will appreciate that the spirit and scope of the present invention is not limited to any one operating system. Local wireless interface mechanism 123 is a software mechanism that includes one or more communication protocols 124 that define how to communicate with the wireless devices of companies, such as package shippers, via local wireless interface 152. Each communication protocol 124 is a specification of how data is transmitted to and received from a corresponding mobile wireless device used by a company. For example, if UPS, FedEx, and the U.S. Postal Service all desire to interact with the web server computer system 100 via the local wireless interface 152, communication protocols 124 would include a UPS protocol, a FedEx protocol, and a USPS protocol that each determine what information is expected in a first digital message from the company, what information to send to the company in a second digital message, and how to send it. One way in which computer system 100 differs from the prior art is the use of communication protocols 124 that define how to communicate with wireless devices from different companies and organizations.

In the preferred embodiments, local wireless interface mechanism 123 is compatible with the Bluetooth wireless communication protocol, and each protocol 124 is preferably a protocol defined and implemented within the Bluetooth protocol. Note that the protocols discussed herein do not currently exist in the Bluetooth specification, but may be implemented withing the parameters of the Bluetooth specification, and may therefore be Bluetooth-compatible.

Web server mechanism 125 is software that allows the computer system 100 to service requests that are received via network interface 150 and via local wireless interface 152. Web server mechanism 125 is preferably prior art web server software. Web server mechanism 125 is what turns computer system 100 into a web server.

Computer system 100 uses well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, local wireless interface mechanism 123, and web server mechanism 125 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, local wireless interface 152, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

Local wireless interface 152 is used to transfer messages between the local wireless interface mechanism 123 and the local wireless transmitter/receiver 185. A message received by computer system 100 arrives at the local wireless transmitter/receiver 185, and is then transferred via the local wireless interface 152 to the local wireless interface mechanism 123. The local wireless interface mechanism 123 then checks to see if the received message is a message that complies with one of the communication protocols 124 that define valid messages. When a message needs to be transmitted by computer system 100, the message is first formatted according to the appropriate communication protocol 124, then the local wireless interface mechanism 123 sends the message via the local wireless interface 152 to the local wireless transmitter/receiver 185, which in turn transmits the message. Note that local wireless transmitter/receiver 185 is preferably a Bluetooth interface in the preferred embodiments, but other wireless transmitter/receivers are also within the scope of the present invention.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD ROM (e.g., 195 of FIG. 1), and transmission type media such as digital and analog communications links.

Computer system 100 as shown in FIG. 1 shows a computer system that is a web server that may be used at a residence or place of business. Let's take the specific example of a house web server to illustrate the power of having a computer system 100 that includes the capability of sending and receiving local wireless messages via local wireless transmitter/receiver 185. With such a web server, the owner of the house could provide passwords to different people to allow them to access specified information. For example, the owner of the house could give a password to a trusted neighbor that would allow the neighbor to access the house web server to determine if the owner is out of town or on vacation. Thus, if the neighbor sees a truck pull up to the owner's house and start loading furniture, the neighbor could check using the password to see if the owner is on vacation. The neighbor may also be able to see the owner's appointments to see if the visit is scheduled on the owner's calendar, and is therefore expected.

A house web server would also allow neighbors to communicate in other ways. Neighbors could be invited to cook-outs, to see kid's school activities, etc. Neighbors could also notify each other if they are available for a visit, or if they want to be left alone. Providing a house web server with a local wireless transmitter/receiver provides many powerful options to the homeowner, particularly when interacting with providers of products and services, discussed in more detail below.

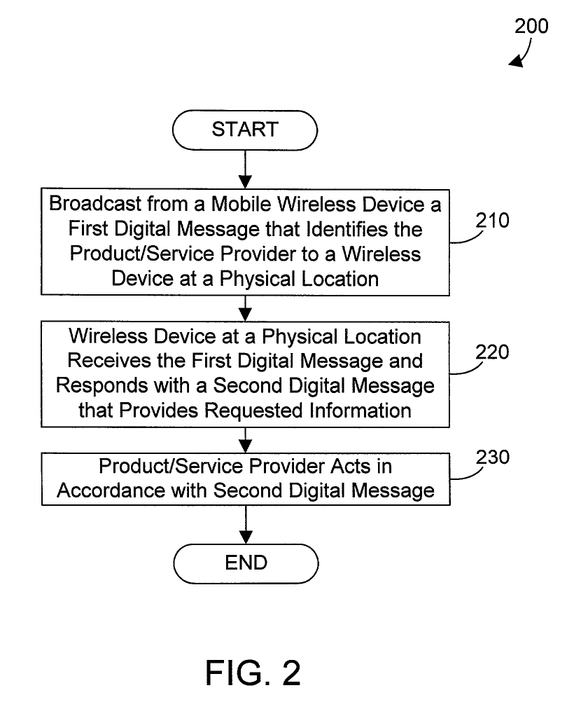

The preferred embodiments include methods for doing business. Referring to FIG. 2, a method 200 for doing business begins by broadcasting from a mobile wireless device, such as in a vehicle or hand-held by a person, a first digital message that identifies the product/service provider to a wireless device at a physical location (step 210). This step is preferably performed when the company's representative is in proximity to the physical location so the wireless device at the physical location is in range of the mobile wireless device that is broadcasting the first digital message. In response to receiving the first digital message, the wireless device at the physical location sends a second digital message that provides information to the mobile wireless device (step 220). The company representative can then act in accordance with the information received in the second digital message (step 230). Steps 210, 220 and 230 are broad steps that cover a number of different detailed methods of doing business, discussed in detail below.

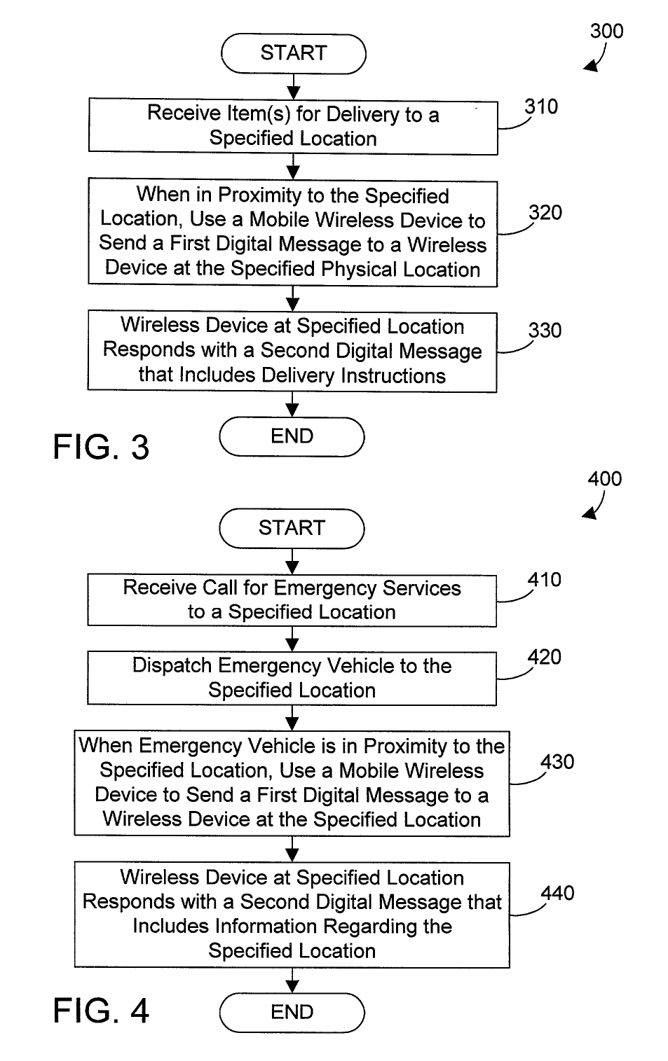

One method for doing business in accordance with method 200 of FIG. 2 is shown in FIG. 3. We assume for method 300 that the company doing business is a shipper of letters and/or packages, such as UPS, FedEx, and the U.S. Postal Service. The first step in method 300 is that the company receives one or more items that need to be delivered to a specified location (step 310). In the preferred embodiments, the specified location is preferably an address, but could alternatively be coordinates of longitude and latitude, map sections or coordinates, or any other suitable way for indicating physical location. The item or items are then taken towards the physical location, either by vehicle or by a person walking. When the vehicle is within range of the specified location, the delivery person uses a mobile wireless device to send a first digital message (step 320). The wireless device at the specified location receives the first digital message, determines from the communication protocols 124 what company is sending a message, formats an appropriate response according to the communication protocol 124 for the company, and sends the response to the mobile wireless device in a second digital message (step 340). Note that the second digital message preferably includes delivery instructions that tell the person delivering the item(s) whether or not to deliver, where to deliver, what time to deliver, etc.

Method 300 may be used by many different types of companies, such as a shipping company (e.g., UPS or FedEx), the U.S. Postal Service in delivering mail, or a newspaper company in delivering newspapers. Several examples are provided below to illustrate specific applications of method 300.

In one example, we assume that UPS uses method 300 to do business with its customers. In step 310, let's assume that UPS receives a package addressed to a specified address. The package is loaded into a UPS delivery truck, and the truck then drives toward the specified address on the package. We assume for this example that the driver drives to the specified address, which we assume is a house, and parks the delivery truck on the curb in front of the house. The driver then broadcasts the first digital message to a web server in the house via a Bluetooth-compatible transmitter, such as a transmitter mounted on the vehicle or a hand-held transmitter (step 320). Assuming that the house at the specified address has a compatible wireless device, the first digital message is received, which identifies the message as coming from UPS in a communication protocol 124 defined for UPS messages. Additional information could also be sent as part of the first digital message, including the number of packages, the size and weight of each package, etc. With detailed information that includes package number, size and weight, the delivery instructions could be custom-tailored to these package parameters.

The wireless device in the house responds to the first digital message by sending a second digital message that includes delivery instructions (step 320). Delivery instructions may state, for example, to ring the doorbell if between the hours of 8:00 AM and 3:30 PM, and if not home, to leave the package in the enclosed back porch. Delivery instructions could also state, for example, that if the package is small enough (such as an express letter), to slip the package through a mail slot on the front door. In addition, delivery instructions could also state that the occupants of the house are on vacation, and to please re-try delivery on a particular date and time when the occupants will have returned. Delivery instructions may also include an electronic key or combination to an electronic lock that protects access to a secure area, such as an enclosed porch. In this manner an electronic key that is time-sensitive may be provided by the customer's wireless device so that the electronic key is only valid for a specified time window, for a specified number of minutes or hours after the electronic key is first used, or for one use only.

Method 300 is also suitable for delivery of mail by the U.S. Postal Service. A piece of mail is received with a person's name and address (step 310). The mail item is then taken to the area of the address, and the letter carrier uses a hand-held mobile wireless device to send a first digital message to the wireless device at the address (step 320). The wireless device at the address responds to the first digital message by sending a second digital message that includes delivery instructions (step 330). Note that delivery instructions may include instructions to not deliver the mail. This feature is especially useful in suspending mail delivery when a person is on vacation.

A newspaper company could also use method 300 to deliver its newspapers. First, newspapers are received for delivery to specified addresses (step 310). When in proximity to one of the addresses, the newspaper carrier uses a hand-held wireless device to send a first digital message to a wireless device at that address (step 320). In response, the wireless device at that address sends a second digital message to the hand-held wireless device that includes delivery instructions (step 330). Again, delivery instructions may include instructions to not deliver the newspaper.

Another method for doing business that is within the scope of method 200 shown in FIG. 2 is method 400 shown in FIG. 4. Method 400 is a method for an emergency service company to do business. Examples of emergency service companies include police, security, firefighters, emergency medical personnel, etc., whether privately owned or operated by government entities. Method 400 begins when a call is received for emergency services to a specified location (step 410). An emergency vehicle is then dispatched to the specified location (step 420). When the emergency vehicle is in proximity to the specified location, a mobile wireless device is used (in the vehicle or hand-held) to send a first digital message to a wireless device at the specified location (step 430). When the wireless device at the specified location receives the first message, it determines from the appropriate communication protocol 124 what emergency service company or agency sent the message, then determines from the corresponding communication protocol 124 an appropriate response. The wireless device at the specified location responds to the first digital message by sending a second digital message to the mobile wireless device, where the second digital message includes information regarding the specified location (step 440).

One type of information that may be provided in the second digital message is a floor plan of the building. Another type of information includes occupancy information for the building, which may include an indication of where people are located in the building. Such occupancy information could be a specification of where people are usually located in the building. For example, occupancy information for a house might highlight bedrooms on a floor plan of the house if a fire alarm is received. Occupancy information could also include information from sensors in the specified location. For example, motion sensors or body heat sensors (occupancy sensors) in a security system could indicate to emergency personnel where in the building people are currently detected from their motion or body heat. This is especially useful for firefighters, but occupancy information could also be very helpful for police responding to a burglar alarm. If, for example, a motion sensor detects a person in the living room, and no other person is present in the house, the police will have a good idea from that information that the burglar is in the living room, and can thus customize their plan for apprehending the burglar around his location in the house. Another way to provide occupancy information is by providing a transmitter on each person that indicates their whereabouts. This would be easy to do in a business environment where employees are required to wear identification badges. A transmitter could be embedded or attached to the identification badge that would allow a computer system to detect the presence of each person in the building. This information could then be transmitted to the emergency service company or agency so they know where people are located within the building.

Another type of information that may be provided in the second digital message relates to the status of certain items at the specified location. Such items may include any monitored area or apparatus. Thus, in a factory environment that includes monitors for toxic fumes, the second digital message may include information about areas of a building where toxic fumes are detected so that emergency service personnel know better how to respond to the emergency.

Other types of information about a specified location could also be returned to emergency response personnel in the second digital message. For example, a maximum security prison could include a system that monitors the status of all fences, gates, doors and windows in the facility. When an alarm sounds, police or guards responding to the alarm may receive information in the second digital message about any fence that is cut, gate that is open, and any open door or window to quickly apprehend the escaped convict. Similarly, let's assume the specified location is a property that includes a warehouse on a large tract of land that is surrounded with security gates and electric fences. When emergency response personnel respond to a call from this property, the information from the second message may include an indication of whether the electric fence is activated or not, may include directions to an entrance that includes an electronic lock, may include an electronic key or combination that the personnel may enter into the electronic lock to gain access, etc. The information regarding the specified location in the second digital message may include any and all information regarding any aspect of the specified location.

Some examples are presented below as specific applications for method 400 of FIG. 4. For example, let's assume that someone in a house dials 911 to ask for the police because he or she fears an intruder is in the house (step 410). The police respond by dispatching a patrol car to the house address (step 420). When the police car comes within range of the house, a mobile wireless device is used to send a first digital message to a wireless device in the house (step 430). In response, the wireless device in the house sends a second digital message that includes information regarding the house (step 440). This information may include, for example, a floor plan of the house with occupancy information derived from motion sensors that are part of a security system in the house. This occupancy information may help the police to identify the location of the perpetrator in the house. For example, let's assume that during the 911 call the person reports they are in the northeast bedroom on the main level of the house, that they are the only person home, and that they are hiding under the bed. Let's further assume that the 911 operator tells the person to stay put under the bed until the police come in the bedroom to rescue them. If the occupancy information indicates from the motion sensors that someone is in the kitchen or the living room, the police will know the whereabouts of the perpetrator, and can thus plan more effectively how to apprehend the perpetrator based on the floor plan of the house and the location of the perpetrator.

Now let's assume that someone in the house dials 911 to report a fire in a house (step 410). The firefighters respond by dispatching a fire truck to the house address (step 420). When the fire truck comes within range of the house, a mobile wireless device is used to send a first digital message to a wireless device in the house (step 430). In response, the wireless device in the house sends a second digital message that includes information regarding the house (step 440). Again, the information may include floor plan and occupancy information. The occupancy information could be a static indication of where people are normally located in the house, or could include a dynamic indication that is derived from sensors (such as motion sensors or body heat sensors) or that is derived from transmitters worn by the persons in the building. In this manner the firefighters could receive real-time information of where people are currently located in a house or other building, which will help the firefighters to concentrate on saving the lives of any persons trapped. In addition, certain fire hazards could be indicated on the floor plan or elsewhere in the second digital message, such as the presence of gasoline tanks, propane tanks, explosive chemicals, etc. The information regarding the specified location that is included in the second digital message may be any suitable information regarding the specified location.

Let's assume now that a man (resident) in the house dials 911 to request medical assistance because he believes he is having a heart attack (step 410). An emergency medical vehicle is then dispatched to the specified location (step 420). The emergency medical vehicle preferably transports qualified emergency medical personnel, such as paramedics, Emergency Medical Technicians (EMTs), or ambulance personnel. When the vehicle comes in proximity to the specified location, the emergency medical personnel use a mobile wireless device to transmit a first digital message to a wireless device at the specified location (step 430). In response, the wireless device at the specified location transmits a second digital message that includes information regarding the specified location (step 440). Again, this information could include a floor plan and occupancy information. Let's assume that an elderly man lives alone, and has an emergency transmitter on a necklace around his neck. When the emergency medical personnel arrive, they may receive the floor plan and the location of the person in the second digital message, which gives them the information they need to quickly locate the man. Note that method 400 expressly applies to any type of company that provides any type of emergency services.

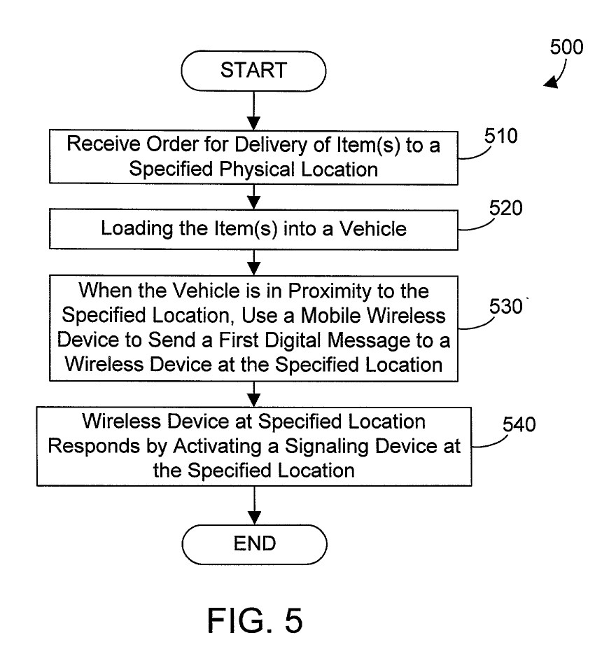

We now present in FIG. 5 another method of doing business that is within the scope of the method 200 in FIG. 2. Method 500 in FIG. 5 may be used by any company that needs to deliver products to people, and is especially useful for food delivery, such as pizza delivery. First, an order is received for the delivery of one or more items to a specified location (step 510). The items are then loaded into a vehicle (step 520). When the vehicle is in proximity to the specified location, a mobile wireless device sends a first digital message to a wireless device at the specified location (step 530). The wireless device at the specified location then responds by activating a signaling device at the specified location (step 540). The purpose of the signaling device is to simplify the process of locating the specified location. For example, the signaling device may include a Bluetooth-enabled wall switch that controls a porch light. When a pizza delivery person comes within range of the specified address, the first digital message in step 530 may be sent. In response, the porch light could be flashed on and off repeatedly by the Bluetooth-enabled wall switch, which allows the delivery person to easily determine which house is the correct house for the delivery. Note that the signaling device may include any suitable visual or audio signaling device, or any device that sends an electronic signal to the delivery person to help the locate the house. One suitable example of an audio signaling device is a speaker located on the front porch that plays a familiar tune or sequence of tones to aid the driver in finding the correct house. One suitable example of an electronic signaling device is for the wireless device at the specified address to send an image of the house to the mobile wireless device used by the delivery person, which could include an arrow or other indicator pointing to a location where the customer wants the items delivered. An image would be more effective during daylight hours than a flashing porch light, which may be difficult to see. Note that method 500 may also include the step of the customer providing a time-sensitive key when placing the order that allows the delivery person to activate the signaling device only during a specified time window.

A specific example that is within the scope of method 500 is now presented. Let's assume that a person in a house orders a pizza from a local pizza delivery company (step 510). Note that this order could be phoned in, or could be placed live or via an internet menu. Once the pizza is cooked, it is loaded into a vehicle (step 520), and the driver drives to the neighborhood of the specified physical location. When close to the house, the driver activates a hand-held mobile wireless device to send a message to a wireless device at the specified location (step 530). In response, the wireless device at the specified location responds by activating a signaling device that pulses a porch light on and off repeatedly (step 540). This provide a visual indication to the driver of which house is the right house for the delivery. Note that Bluetooth-enabled wall switches and relays are not known in the art, and represent novel devices that may be used as a signaling device in method 500.

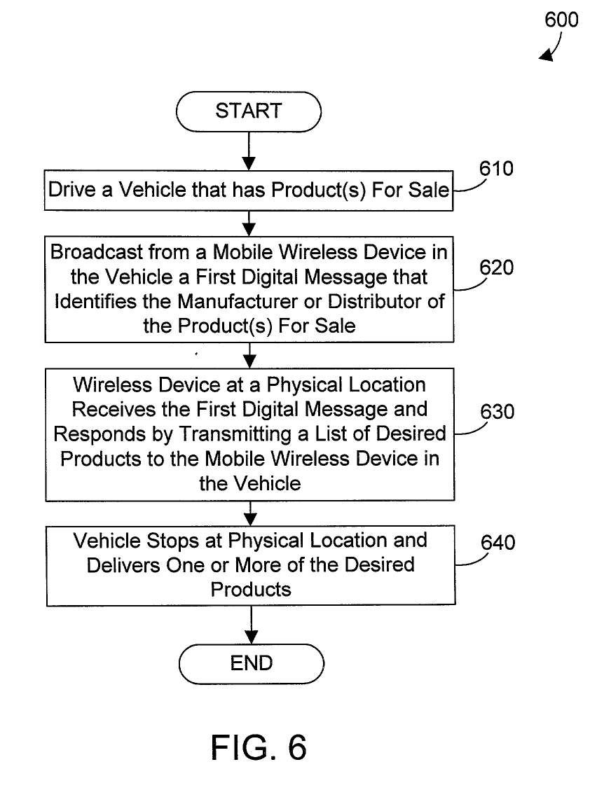

Yet another method that is within the scope of method 200 in FIG. 2 is shown in FIG. 6. Method 600 may be used by a company that sells products from its vehicles. First, a vehicle that contains or otherwise transports products for sale is driven to a particular area (step 610). A mobile wireless device is then used to broadcast a first digital message that identifies the manufacturer or distributor of products for sale (step 620). A wireless device at a physical location that receives the first digital message may respond by transmitting a list of desired products (step 630). The vehicle can then stop at the physical location and deliver one or more of the desired products (step 640). Method 600 is very useful for companies that sell products directly from a vehicle.

One specific example of a company that could benefit from using method 600 of FIG. 6 is a company that sells dairy products, including milk, cheese, ice cream, etc. The company could load up a delivery truck with the dairy products (step 610). As the driver drives around neighborhoods or businesses, a mobile wireless device (either vehicle-mounted or hand-held) could continuously transmit a first digital message that indicates that the delivery truck is nearby. When a wireless device at a physical location receives the first digital message, it may respond by sending a list of products that the occupants of the physical location wish to purchase (step 630). The driver could then direct the vehicle to the location and sell the listed products (step 640). Note that a wireless transmitter at a physical location will generally respond to the first digital message only when it has been programmed to order products from this particular company. For example, a person may view a list of available products, such as on a printed flyer or on a web site. The person may then enter into an electronic order form the product(s) the person wishes to purchase. The ordering information may include a schedule for the next time the delivery truck will be in the neighborhood, or may simply store the order until the next time the delivery truck comes by. In the alternative, the order may include a standing order (such as 2 gallons of milk and 1 pint of cottage cheese every Thursday) that is transmitted to the delivery truck at the appropriate time when it is in the neighborhood.

Note that many variations are possible within the scope of method 600. For example, the information in the first digital message may only include the name of the manufacturer or distributor, but could also include other information as well, such as an inventory of products available on the truck. The list of desired products in step 630 may include products that are not available on the truck, which could result in either the additional products being back-ordered for the next pass through the area by the delivery truck, or the additional products being not delivered and canceled from the order. In addition, the vehicle may stop in step 640 to deliver only a portion of the order if some of the products are not available on the delivery truck. Similarly, the list of products in step 630 may include a specified day and time of delivery for some time in the future, which would require the delivery truck to return to the physical location at the appointed time to make the delivery of products in step 640. In addition, the customer could provide en electronic key that the driver could use to determine if there is anybody home that can accept delivery of the items. These and other variations are within the scope of method 600 in FIG. 6.

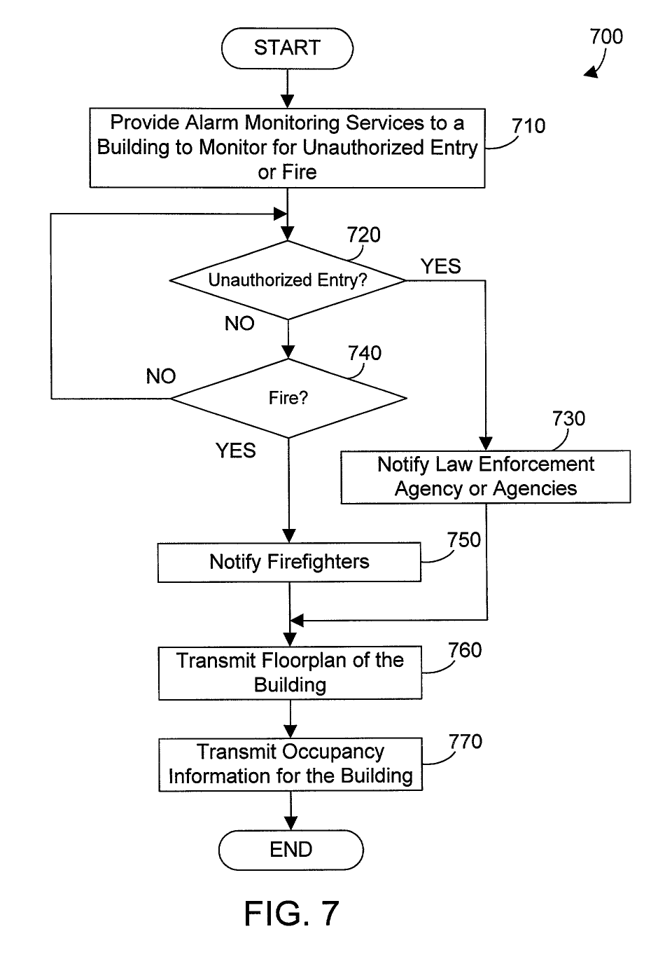

Another method for doing business within the scope of the preferred embodiments is shown in FIG. 7. Method 700 may be performed by a company (such as a security company) that provides alarm monitoring services to a building or property. We assume for method 700 in FIG. 7 that the monitoring service includes monitoring for unauthorized entry or fire (step 710). Note, however, that any type of monitoring is within the scope of method 700. If an unauthorized entry is detected (step 720=YES), one or more law enforcement agencies are notified (step 730). The floor plan of the building may then be transmitted to the law enforcement agency (step 760), as well as occupancy information for the building (step 770). The floor plan and occupancy information could then be transmitted by the police dispatch to the officers arriving at the scene to provide more information on how to appropriately handle the call. Occupancy information may include any suitable information that helps determine where people may be in the building. As stated above for method 400 in FIG. 4, occupancy information could be in the form of a specification of which areas of a building are normally occupied at different times of day, and could be dynamically generated from sensors within the building or by transmitters worn by the occupants of the building.

If fire is detected (step 740=YES), firefighters are notified (step 750), and the floor plan of the building is transmitted (step 760) along with occupancy information (step 770). Firefighters can thus benefit from having the floor plan and occupancy information in determining how to best fight the fire. Method 700 provides a competitive advantage when compared to prior art methods because the information transmitted to the firefighters or police in steps 760 and 770 provide critical information that help these rescue personnel better protect customers paying for the monitoring services.

Note that the methods in FIGS. 2-6 may use a wireless house server as shown by computer system 100 in FIG. 1 as the customer's wireless device, and exchange wireless messages with mobile wireless devices via local wireless transmitter/receiver 185. However, it is equally within the scope of the preferred embodiments to use other types of devices, including stand-alone wireless transmitter/receivers, as the customer's wireless device that receives the first digital message and sends the second digital message. For example, the customer may have a personal digital assistant (PDA) that is Bluetooth-enabled, and may program the PDA with the communication protocols 124 that allow the PDA to receive the first digital message and to transmit a second digital message according to the communication protocols 124. The methods for doing business expressly extend to any and all types of wireless devices a customer may use to receive a first digital message from a product/service provider and to send a second digital message to the product/service provider.

Note that each of the methods disclosed herein may optionally include authentication and authorization functions. Thus, when a customer's wireless device receives a first digital message, the customer may perform authentication and authorization functions on the first digital message to determine the content of the second digital message. For example, police and fire crews may be given sensitive information (such as whether or not a customer is home), while commercial entities may not be authorized to receive this information. Each communication protocol 124 may include authentication and authorization information that may affect the contents of the second digital message, or may control whether any second digital message is sent.

The preferred embodiments include a computer system, program product, and methods for doing business that allow sellers of products or providers of services to receive information from a customer to determine how to best server the customer's needs. By providing wireless automatic data exchange between providers and consumers, many old-fashioned ways of doing business may be upgraded to reflect the advances in technology provided by local wireless communications, such as Bluetooth. One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A computer system comprising:
at least one processor;
a memory coupled to the at least one processor;
a local wireless interface coupled to the at least one processor;
a local wireless transmitter/receiver coupled to the local wireless interface;
a network interface coupled to the at least one processor and coupled to a network;
a web server mechanism residing in the memory and executed by the at least one processor, the web server mechanism servicing requests on the network interface and on the local wireless interface; and
a local wireless interface mechanism residing in the memory and executed by the at least one processor, the local wireless interface mechanism including at least one communication protocol that specifies how the local wireless interface interacts with a mobile wireless device of a product/service provider.

2. The computer system of claim 1 wherein the local wireless interface and the local wireless interface mechanism are part of a Bluetooth-compatible wireless interface.

3. A method for doing business, the method comprising the steps of:
(A) broadcasting from a mobile wireless device a first digital message that identifies a product/service provider to a second wireless device at a specified physical location;
(B) in response to receiving the first digital message, the second wireless device transmits a second digital message to the mobile wireless device, the second digital message including information regarding the specified physical location; and
(C) the product/service provider acting in accordance with information contained in the second digital message.

4. A method for doing business, the method comprising the steps of:
(A) receiving at least one item for delivery to a specified physical location;
(B) when within a predetermined range from the specified physical location, using a first wireless device to send a first digital message to a second wireless device at the specified physical location; and
(C) in response to receiving the first digital message, the second wireless device transmits a second digital message to the first wireless device, the second digital message including delivery instructions for delivering the at least one item to the specified physical location.

5. The method of claim 4 wherein the first digital message identifies the company that received the at least one item in step (A).

6. The method of claim 5 wherein the first digital message further identifies the at least one item.

7. The method of claim 4 wherein the delivery instructions specify to not deliver the at least one item.

8. The method of claim 4 wherein the delivery instructions include an electronic key that is used to place the at least one item in a secure location.

9. The method of claim 4 further comprising the step of the second wireless device performing authentication and authorization functions in response to receiving the first digital message to assure the first wireless device is authorized to communicate with the second wireless device.

10. A method for providing emergency services, the method comprising the steps of:
(A) when a call for emergency services is received for a specified physical location, dispatching an emergency vehicle to the specified physical location;
(B) when within a predetermined range from the specified physical location, using a first wireless device to send a first digital message to a second wireless device at the specified physical location; and
(C) in response to receiving the first digital message, the second wireless device transmits a second digital message to the first wireless device, the second digital message including information specific to the specified physical location.

11. The method of claim 10 wherein the information specific to the specified physical location comprises a floor plan of at least one building at the specified physical location.

12. The method of claim 10 wherein the information specific to the specified physical location comprises occupancy information that indicates whether at least one room in the specified physical location contains people.

13. The method of claim 12 wherein the occupancy information is derived from information that defines which areas of the specified physical location typically contain people.

14. The method of claim 12 wherein the occupancy information is dynamically derived from at least one sensor that detects the presence of people in the room.

15. The method of claim 12 wherein the occupancy information is dynamically derived from at least one transmitter carried by at least one person at the specified physical location.

16. The method of claim 10 wherein the emergency services comprise police services.

17. The method of claim 10 wherein the emergency services comprise fire fighting services.

18. The method of claim 10 wherein the emergency services comprise emergency medical services.

19. The method of claim 10 wherein the emergency services comprise security services.

20. A method for doing business, the method comprising the steps of:
(A) receiving an order for delivery of at least one item to a specified physical location;
(B) loading the at least one item into a vehicle;
(C) when the vehicle is within a predetermined range from the specified physical location, using a first wireless device to send a first digital message to a second wireless device at the specified physical location; and
(D) in response to receiving the first digital message, the second wireless device activating a signaling device that identifies the specified physical location.

21. The method of claim 20 wherein the signaling device comprises a flashing light.

22. The method of claim 20 wherein the signaling device comprises an audio device that plays at least one audible signal.

23. The method of claim 20 wherein the signaling device comprises a Bluetooth-enabled switch that allows a light to be turned off and on via at least one wireless command.

24. The method of claim 20 wherein the first digital message includes a time-sensitive key that was provided by a customer at the specified physical location when the order was taken.

25. A method for doing business, the method comprising the steps of:
(A) driving a vehicle that transports at least one product for sale;
(B) sending via a first wireless device a first digital message that identifies a manufacturer or distributor for the at least one product for sale;
(C) in response to receiving the first digital message, a second wireless device at a specified physical location transmits a second digital message to the first wireless device, the second digital message providing a list of products a consumer at the specified physical location desires to purchase; and
(D) stopping at the specified physical location to deliver at least one product that is on the list of products.

26. The method of claim 25 wherein if the vehicle is not transporting sufficient products to deliver the list of products, generating an order for products on the list of products that are not available on the vehicle.

27. The method of claim 25 wherein the second digital message indicates whether there is anybody at the specified physical location that can accept delivery.

28. A method for doing business, the method comprising the steps of:
(A) providing alarm monitoring services to a building to monitor for unauthorized entry;
(B) when unauthorized entry is detected, notifying at least one law enforcement agency;
(C) transmitting to the at least one law enforcement agency a floor plan of the building; and
(D) transmitting to the at least one law enforcement agency occupancy information for at least one room in the building.

29. The method of claim 28 wherein the occupancy information is derived from information that defines which areas of the building typically contain people.

30. The method of claim 28 wherein the occupancy information is dynamically derived from at least one sensor that detects the presence of people in the at least one room.

31. The method of claim 28 wherein the occupancy information is dynamically derived from at least one transmitter carried by at least one person in the building.

32. A method for doing business, the method comprising the steps of:
(A) providing alarm monitoring services to a building to monitor for fire;
(B) when a fire is detected, notifying at least one firefighting agency;
(C) transmitting to the at least one firefighting agency a floor plan of the building; and
(D) transmitting to the at least one firefighting agency occupancy information for at least one room in the building.

33. The method of claim 32 wherein the occupancy information is derived from information that defines which areas of the building typically contain people.

34. The method of claim 32 wherein the occupancy information is dynamically derived from at least one sensor that detects the presence of people in the at least one room.

35. The method of claim 32 wherein the occupancy information is dynamically derived from at least one transmitter carried by at least one person in the building.

36. A program product comprising:
(A) a local wireless interface mechanism that includes at least one communication protocol that specifies how a local wireless interface interacts with a mobile wireless device of a product/service provider; and
(B) computer-readable signal bearing media bearing the local wireless interface mechanism.

37. The program product of claim 36 wherein the computer-readable signal bearing media comprises recordable media.

38. The program product of claim 36 wherein the computer-readable signal bearing media comprises transmission media.

39. The program product of claim 36 wherein the local wireless interface mechanism is part of a Bluetooth-compatible wireless interface.
